(19) United States
(12) Patent Application Publication
(10) Pub. No.: US 2026/0003718 A1
(43) Pub. Date: Jan. 1, 2026

(54) ERROR HANDLING MANAGEMENT CORE

(71) Applicant: Advanced Micro Devices, Inc., Santa Clara, CA (US)

(72) Inventors: Carlos Vallin, Austin, TX (US); Vilas Sridharan, Boxborough, MA (US); Magiting Talisayon, Boxborough, MA (US); Kasir Asad Watkins, Fishkill, NY (US)

(73) Assignee: Advanced Micro Devices, Inc., Santa Clara, CA (US)

(21) Appl. No.: 18/936,899

(22) Filed: Nov. 4, 2024

Related U.S. Application Data
(63) Continuation-in-part of application No. 18/754,264, filed on Jun. 26, 2024.

(51) Int. Cl. G06F 11/07

(52) U.S. Cl. CPC G06F 11/0787; G06F 11/0721

(57) ABSTRACT

The disclosed device includes a processor core and a management core. The management core can intercept error interrupts indicating errors for the processor core. The management core can process the error while the processor core continues operations, and can also cloak the error from an operating system. The management core can also provide the errors to a baseboard controller for storing in a non-volatile memory. Various other methods, systems, and computer-readable media are also disclosed.

### CROSS REFERENCE TO RELATED APPLICATION

This application is a continuation-in-part of U.S. application Ser. No. 18/754,264, filed Jun. 26, 2024, the disclosure of which is incorporated, in its entirety, by this reference.

### BACKGROUND

A computing device has various mechanisms to address hardware faults, such as faults relating to a processor core (e.g., a processing unit of a central processing unit (CPU) which may have multiple processing units). For instance, an interrupt system allows interrupts to take precedence over normal program instruction execution. Further, a system such as Machine Check Architecture (MCA) allows detecting and reporting hardware errors to an operating system (OS) of the computing device. However, reporting every error to the OS can be undesirable and unnecessary for certain errors that can be corrected. Further, using a processor core for reporting errors, such as to the OS or to another controller (e.g., an external management controller), may take processing cycles away from completing a normal workload.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for an error handling processor.

FIGS. 2A-C are diagrams of error cloaking.

FIGS. 3A-B are a flow diagrams of an example method for managing errors with an error handling processor.

FIG. 4 is a diagram of an example architecture for out-of-band error reporting.

FIG. 5 is a diagram of an example signal flow for out-of-band error reporting.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a processor having a management core for error handling without visibility to an operating system. As will be explained in greater detail below, implementations of the present disclosure include a management core that can process machine errors independently from a processor core as well as cloaking the error from an operating system as needed. Further, in some implementations, the management core can report errors to a non-volatile memory (e.g., OOB reporting) or otherwise allow an external controller (e.g., external to the processor) to access the errors to allow storing error logs even after system shutdown/reboot. The systems and methods described herein advantageously allow improved error handling.

Features from any of the implementations described herein can be used in combination with one another in accordance with the general principles described herein. These and other implementations, features, and advantages will be more fully understood upon reading the following detailed description in conjunction with the accompanying drawings and claims.

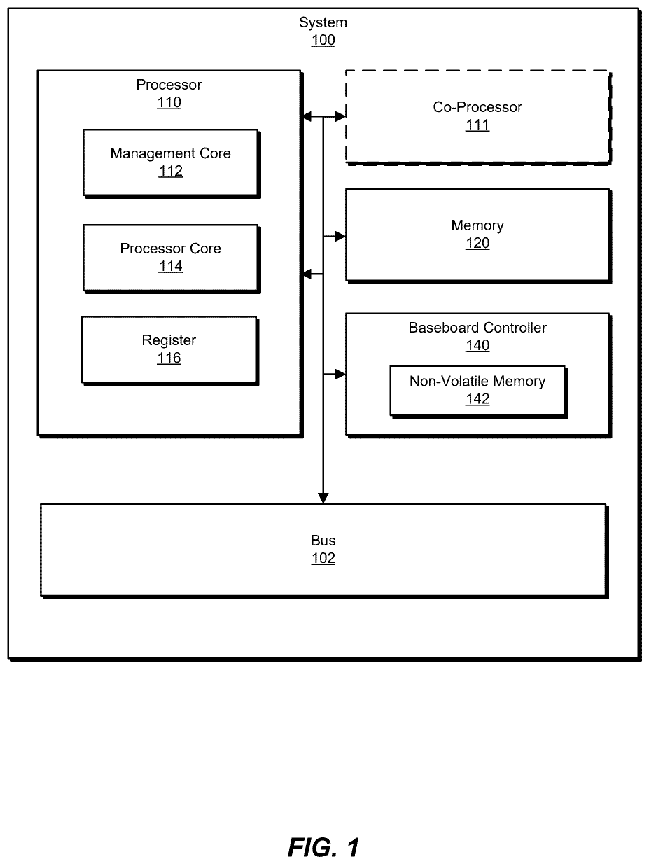

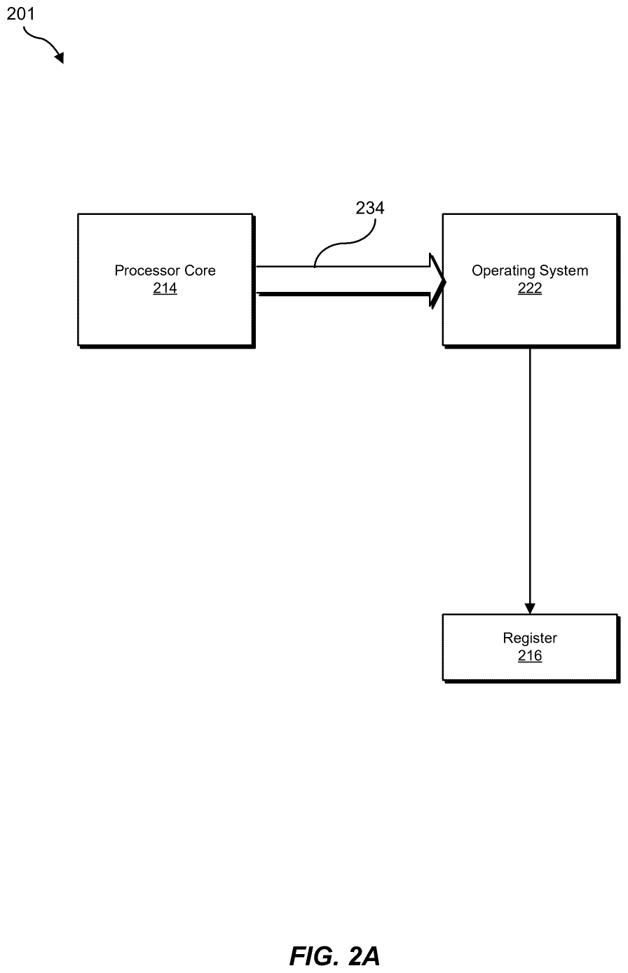

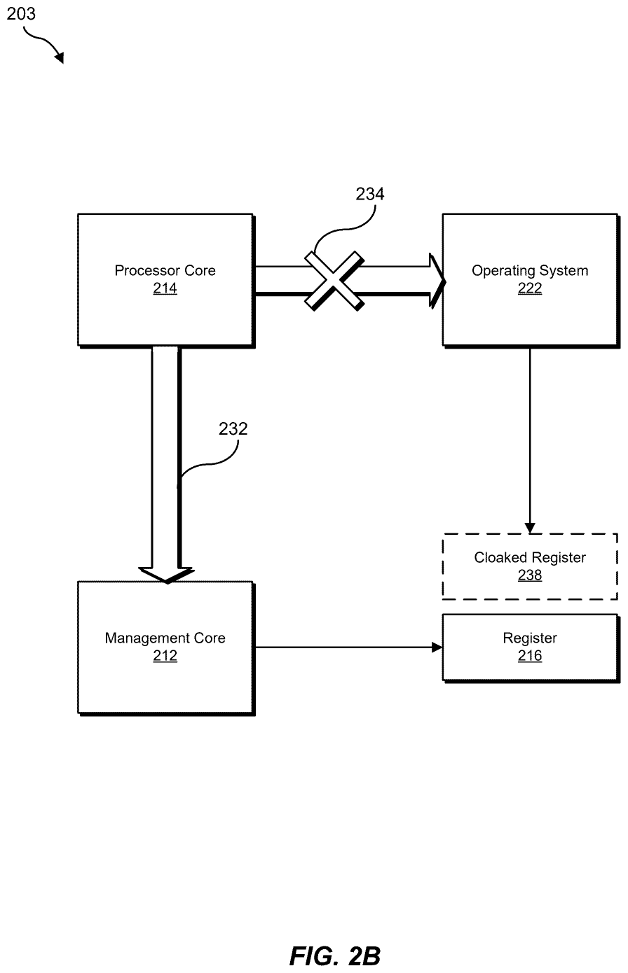

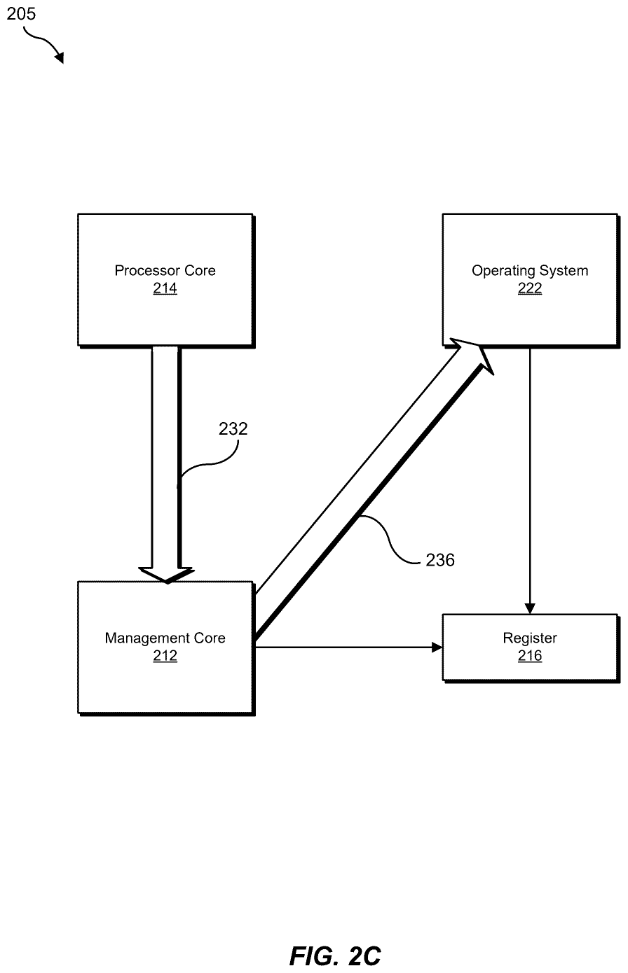

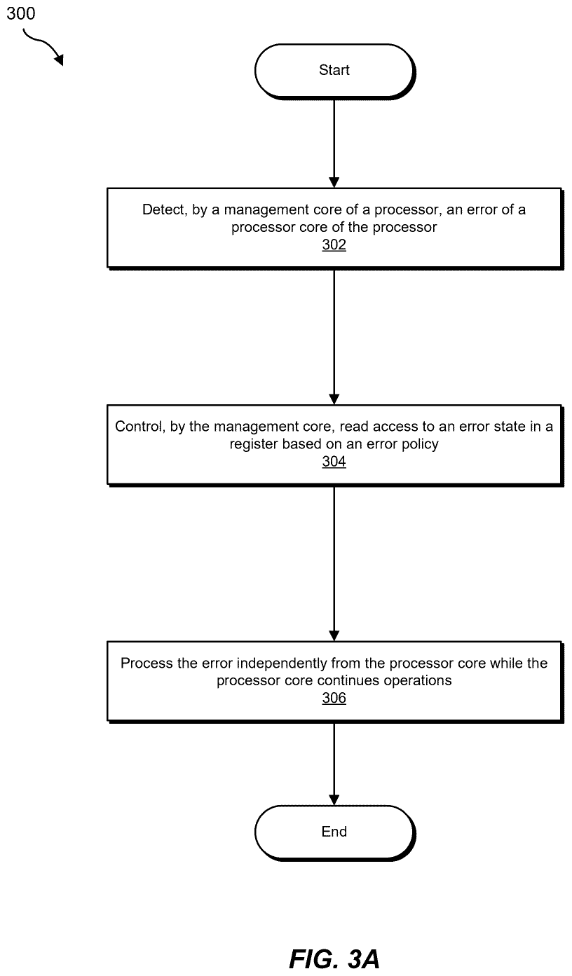

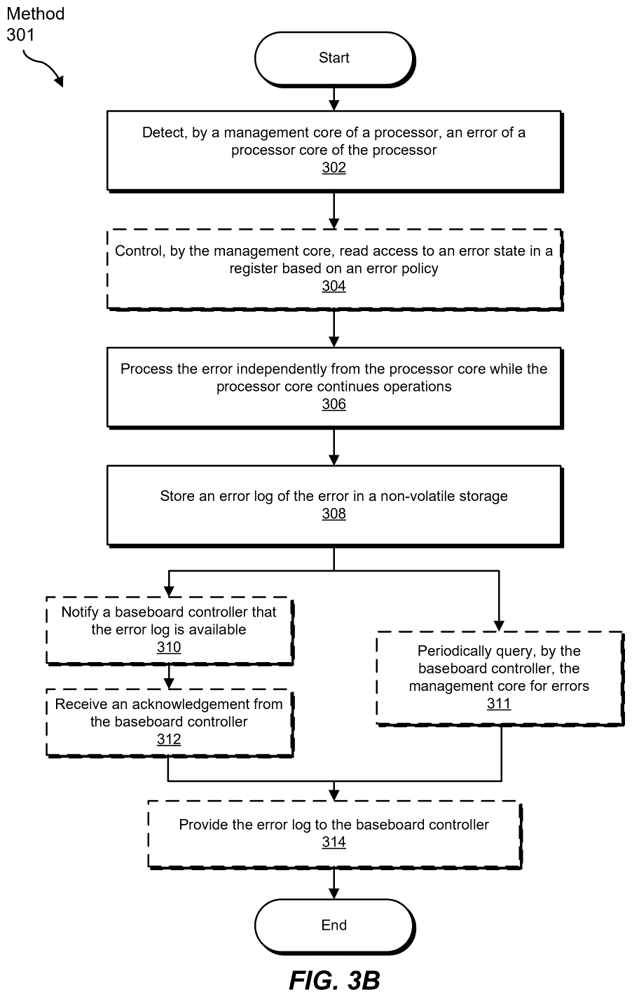

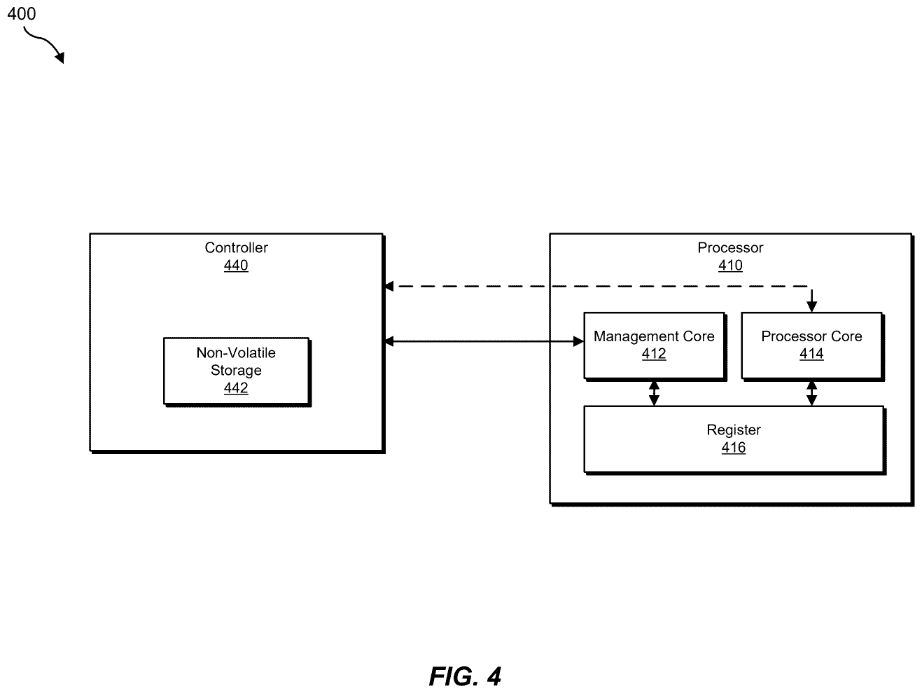

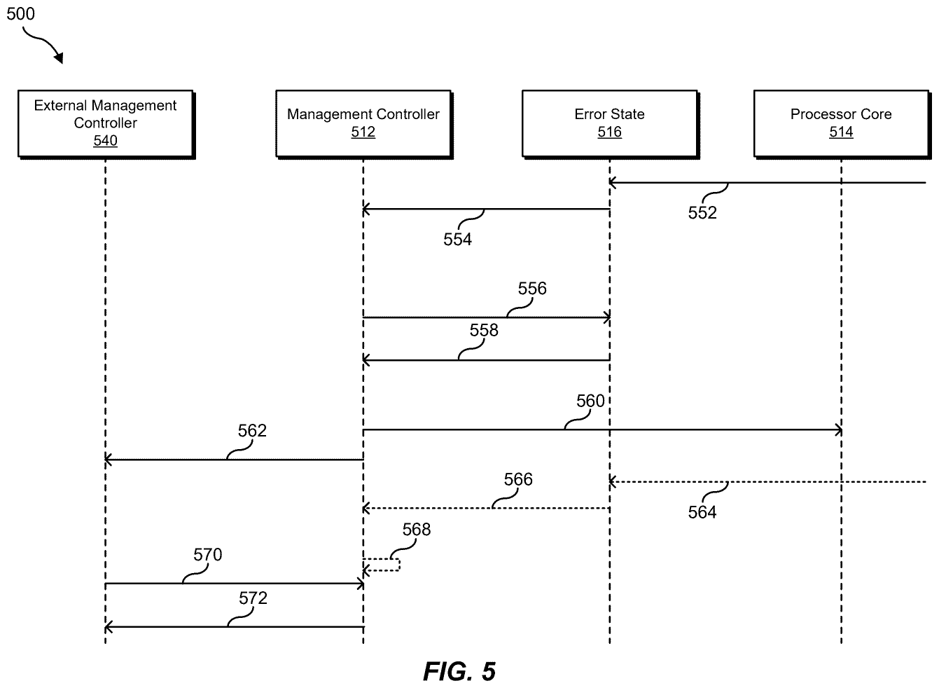

The following will provide, with reference to FIGS. 1-5, detailed descriptions of example architectures with an error handling processor core. Detailed descriptions of example systems will be provided in connection with FIG. 1. Detailed descriptions of error cloaking will be provided in connection with FIGS. 2A-2C. Detailed descriptions of corresponding computer-implemented methods will also be provided in connection with FIGS. 3A-3B. Detailed descriptions of an example OOB error reporting layout will be provided in connection with FIG. 4. Detailed descriptions of example signals for OOB error reporting will also be provided in connection with FIG. 5.

FIG. 1 is a block diagram of an example system 100 for an error handling processor core. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some examples, system 100 can be coupled to a display through bus 102.

As further illustrated in FIG. 1, processor 110 includes a management core 112, a processor core 114, and a register 116. A core can correspond to an individual processor of a processor chip having multiple cores. Management core 112 corresponds to a core that in some implementations is configured for management tasks, such as error handling. Processor core 114 corresponds to a core of processor 110 that is configured for processing tasks, such as running programs. Register 116 corresponds to a local storage of processor 110 that in some implementations can be used to storing an error state and/or other error information. As will be described further below, management core 112 can manage hardware errors of processor core 114, as indicated in register 116, independently from processor core 114 to allow, in some examples, processor core 114 to continue executing tasks normally.

FIG. 1 also illustrates a baseboard controller 140 having a non-volatile memory 142. Baseboard controller 140 can represent any control circuit such as a microcontroller that may be embedded on a motherboard (e.g., a baseboard management controller (BMC) that can provide out-of-band remote management capabilities for system 100). Non-volatile memory 142 can correspond to any non-volatile storage (e.g., a memory device that can retain stored information even if power is removed such as for a system shut down/reboot) including, for example, floating gate memory cells, floating gate metal-oxide-semiconductor field-effect transistors (MOSFETs), flash memory such as NAND flash or solid state drives, erasable programmable read-only memory (EPROM), electrically erasable programmable ROM (EEPROM), non-volatile random access memory (NVRAM), etc.

FIG. 2A illustrates an error scenario 201 for a processor core 214 (corresponding to processor core 114) and a register 216 (corresponding to register 116, although in other examples can correspond to any register for storing errors, including registers of a peripheral device) with respect to an operating system 222. Processor core 214 can encounter an error, the details of which can be stored in register 216. In some examples, register 216 and/or an associated error architecture can send an interrupt to processor core 214 to inform processor core 214 of the error, although in other examples, other messages and/or interrupts can inform processor core 214.

In response to an error, processor core 214 can report the error to operating system 222 via an error interrupt 234. Operating system 222 can read register 216 for error information and perform a follow up action. For example, operating system 222 can instruct processor core 214 to handle the error, which can require processor core 214 to pause executing tasks (e.g., as provided by operating system 222) or alternatively, operating system 222 can account for an unavailability of processor core 214 as it handles the error. In addition, operating system 222 can notify a user and/or log error information. However, in some instances, having operating system 222 to initially view/respond to errors can be inefficient.

FIG. 2B illustrates an error scenario 203 which can include a management core 212 (corresponding to management core 112). In FIG. 2B, after processor core 214 encounters an error, error interrupt 234 to operating system 222 can be suppressed, such as by actively blocking and/or intercepting error interrupt 234, or omitting error interrupt 234 from a normal error flow. Rather, an error interrupt 232 can be sent to management core 212 to allow visibility of the error to management core 212 (and/or a firmware running on management core 212) before operating system 222. Management core 212 can access register 216 to read the error state/information and address the error accordingly, and more specifically to process the error independently from (and in parallel to) processor core 214. Processing the error can include, for example, taking action in response to the error (e.g., instructing processor core 214 to perform a debugging and/or corrective action, pause operations, and/or shut down), reporting the error as needed, etc. In some implementations, instead of and/or in addition to receiving error interrupts (e.g., error interrupt 232), management core v12 can poll for errors, such as by periodically accessing register 216. In some examples, this allows processor core 214 to continue operations such as executing tasks without having to directly address the error. For instance, processor core 214 can continue after sending error interrupt 232, although in other examples processor core 214 can wait until management core 212 instructs processor core 214 to continue and in yet further examples, management core 212 can instruct processor core 214 to pause (or otherwise not allow processor core 214 to continue operations) based on the error.

In some implementations, management core 212 can include an error policy that controls error visibility to operating system 222. For example, the error policy can be microcode (e.g., firmware in some implementations) and/or other firmware or logic in management core 212 that can be programmable or otherwise configurable. The error policy can indicate which errors and/or types of errors are not visible to operating system 222 and are cloaked (e.g., via interrupts and/or polling), and which errors and/or error types are visible to operating system 222 and are uncloaked. Further, in some implementations, the error policy can be independent from management core 212 (e.g., management core 212 can implement an independent policy for receiving interrupts and/or polling for errors).

In some implementations, cloaking an error includes suppressing an error interrupt to operating system 222 (as described above), and further prevent operating system 222 from reading the error state for the error. In some implementations, when operating system attempts to read register 216, rather than explicitly blocking any read attempts, operating system 222 can instead be redirected to cloaked register 238, which in some examples can refer to a default returned value rather than a physical or logical register, although in other examples can refer to a physical or logical register holding the default value. Accordingly, management core 212 can process the error without visibility to operating system 222 in accordance with the error policy.

In some examples, errors can be cloaked by default, and management core 212 can uncloak errors based on the error policy. For example, certain errors can be uncloaked upon management core 212 first encountering the error, although in other examples management core 212 can later uncloak the error (e.g., in response to correcting the error and/or reaching another milestone, such as an escalation if the error cannot be addressed, which can further be defined in the error policy). FIG. 2C illustrates an error scenario 205 in which management core 212 has uncloaked the error in response to receiving error interrupt 232.

In some implementations, uncloaking the error can include sending an error interrupt (e.g., error interrupt 236 that is separate from error interrupt 232) to operating system 222 as well as allow operating system 222 to access register 216 to read the error state for the error (which in some implementations allows operating system 222 to poll for errors). As illustrated in FIG. 2C, management core 212 can send error interrupt 236 to operating system 222, although in other implementations, uncloaking the error can include allowing rather than suppressing error interrupt 234 (in FIGS. 2A and 2B). Accordingly, management core 212 can uncloak the error in accordance with the error policy.

FIG. 3A is a flow diagram of an exemplary method 300 for error handling with a management core. The steps shown in FIG. 3A can be performed by any suitable computer-executable code and/or computing system, including the system(s) illustrated in FIGS. 1 and/or 2A-2C. In one example, each of the steps shown in FIG. 3A represent an algorithm whose structure includes and/or is represented by multiple sub-steps, examples of which will be provided in greater detail below.

As illustrated in FIG. 3A, at step 302 one or more of the systems described herein detect, by a management core of a processor, an error of a processor core of the processor. For example, management core 112 can receive an error interrupt associated with processor core 114 and/or management core 112 can poll register 116 for error information/state.

The systems described herein can perform step 302 in a variety of ways. In one example, an update to register 116 can trigger an error interrupt, which can be directed to processor core 114, and processor core 114 can send another error interrupt or forward the initial error interrupt to management core 112. In other implementations, the error can trigger an error interrupt to management core 112 directly. In yet other implementations, management core 112 can periodically read/scan register 116 for changes or new error information (not previously addressed), which can further be in response to certain events/triggers.

At step 304 one or more of the systems described herein control, by the management core, read access to an error state in a register based on an error policy. For example, management core 112 can control read access to the error state in register 116.

The systems described herein can perform step 304 in a variety of ways. In one example, management core 212 can prevent read access to register 216 for operating system 222, although in other examples management core 212 can further prevent read access by other agents to register 216 as needed (e.g., based on an error policy). As described herein, management core 212 can cloak the error from operating system 222, which in some examples can include suppressing interrupts and/or preventing error polling.

At step 306 one or more of the systems described herein process the error independently from the processor core while the processor core continues operations. For example, management core 112 can process the error independently from and/or in parallel to processor core 114.

The systems described herein can perform step 306 in a variety of ways. In one example, management core 112 can instruct processor core 114 to continue operations (e.g., processor core 114 can wait on the instruction from management core 112 to continue), although in other examples, processor core 114 can continue operations until instructed otherwise by management core 112 (e.g., management core 112 can confirm the processor core 114 continues or otherwise instructs processor core 114 to pause). In yet further instructions, management core 112 can further instruct processor core 114 with tasks directed to addressing the error (e.g., flushing appropriate data structures/pipelines, powering off, etc.).

The management core can further uncloak the error as indicated by the error policy. For example, the error policy can indicate conditions for reporting the error, such that management core 212 can uncloak the error from operating system 222, which in some examples can further include allowing operating system 222 to poll for errors.

FIG. 3B is a flow diagram of an exemplary method 301 for error handling with a management core as a variation of method 300 in FIG. 3A that includes OOB reporting. The steps shown in FIG. 3B can be performed by any suitable computer-executable code and/or computing system, including the system(s) illustrated in FIGS. 1 and/or 2A-2C. In one example, each of the steps shown in FIG. 3B represent an algorithm whose structure includes and/or is represented by multiple sub-steps, examples of which will be provided in greater detail below. Further, the same steps described in FIG. 3A can be similar to the steps in FIG. 3B.

As illustrated in FIG. 3B, at step 308 (which can follow, be concurrent with, and/or precede step 306) one or more of the systems described herein stores an error log in a non-volatile storage. For example, management core 112 can store an error log (e.g., based on an error state from register 116) in non-volatile memory 142, which in some implementations can be via baseboard controller 140 as will be described further below.

The systems described herein can perform step 308 in a variety of ways. FIG. 4 illustrates an example architecture of a system 400 corresponding to system 100. FIG. 4 includes a processor 410 (corresponding to processor 110) that includes a management core 412 (corresponding to management core 112), a processor core 414 (corresponding to processor core 114), and a register 416 (corresponding to register 116). FIG. 4 also includes a controller 440 (corresponding to baseboard controller 140) that includes a non-volatile storage 442 (corresponding to non-volatile memory 142).

In one example, the management core can directly access the non-volatile storage to store the error state, such as management core 112 writing into a non-volatile memory (e.g., a non-volatile instance of memory 120 via bus 102). In some examples, the error log can correspond to the error state. In some implementations, the error log can represent multiple bit flags, each bit flag representing a different type of error (e.g., such that a bit vector can represent the various types of detectable/trackable errors for the corresponding hardware, and a set bit indicates an error of that type was detected). Further, in some implementations, the error log can include special bit flags to indicate multiple errors of a given type.

In some examples, the management core can provide the error log to the baseband controller to store in its non-volatile memory. In FIG. 4, controller 440 can correspond to a baseboard controller which can manage certain maintenance aspects of a system, including providing remote access or otherwise allowing an administrator to diagnose system errors. Controller 440 can include or otherwise interface with non-volatile storage 442 to store certain logs and information for diagnosis. In some examples, processor core 414 can have an interface to controller 440, which can allow processor core 414 to report detected errors (e.g., as stored in register 416) to controller 440. However, as described above, having processor core 414 perform error management tasks can consume processing cycles that could otherwise be used for normal processing workloads. In other words, as described above, management core 412 can independently perform error management tasks, such as reporting errors to controller 440, to allow processor core 414 to continue operations.

In some implementations, management core 412 can have its own interface (with intervening components as needed, although not illustrated in FIG. 4) to controller 440, although in other examples, the interface can physically coincide with the interface between processor core 414 and controller 440 (e.g., by having an arbitrator or other controller to select between management core 412 and processor core 414). In some examples, management core 412 can allow controller 440 to read register 416, although in other examples, management core 412 may maintain an error log to be provided to controller 440, as will be described further below.

FIG. 5 illustrates an example signal diagram 500 of a system such as system 400 and/or system 100. FIG. 5 includes an external management controller 540 (corresponding to baseboard controller 140 and/or controller 440) a management core 512 (corresponding to management core 112 and/or management core 412), an error state 516 (corresponding to register 116 and/or register 416 or any other storage device and/or representation of error state information for a device), and a processor core 514 (corresponding to processor core 114 and/or processor core 414).

Processor core 514 can exhibit an error that is stored, at 552, in error state 516. Management core 512 can detect the error, at 554, from an interrupt or other appropriate signal (see, also step 302 in FIG. 3A). Management core 512 can, at 556, read error state 516 to determine the type of error at 558 and respond accordingly. In other examples, rather than responding to an interrupt, management core 512 can periodically check error state 516 for new errors stored, such as by periodically repeating 556 (without being a response to 554) and checking error state 516 for any changes since a last time accessing error state 516. For example, at 560, management core 512 can control access to the error for processor core 514 and/or the OS (see, also, step 304 in FIG. 3A). Management core 512 can also process the error independently from processor core 514 (see, also, step 306 in FIG. 3A). As part of processing the error, management core 512 can log the error in a non-volatile memory.

Returning to FIG. 3B, the systems described herein can perform step 308 in a variety of ways. In one example, an update to register 116 can trigger an error interrupt, which can be directed to processor core 114, and processor core 114 can send another error interrupt or forward the initial error interrupt to management core 112. In other implementations, the error can trigger an error interrupt to management core 112 directly. In yet other implementations, management core 112 can periodically read/scan register 116 for changes or new error information (not previously addressed), which can further be in response to certain events/triggers.

At step 310 one or more of the systems described herein notifies a baseboard controller that the error log is available. For example, management core 112 can notify baseboard controller 140 that the error log is available.

The systems described herein can perform step 310 in a variety of ways. In one example, management core 412 can notify controller 440 of detecting the error. Notifying controller 440 allows asynchronous reporting of errors. In some examples, controller 440 can operate at a different clock and/or speed than processor 410 and/or management core 412. In other words, controller 440 can be unavailable to receive the error log from management core 412. For instance, a polling speed of controller 440 can be slower than once per cycle of management core 412. As such, in some examples, multiple errors can be exhibited before controller 440 indicates availability for the error log, such that the error log can track multiple errors.

In FIG. 5, management core 512 can notify external management controller 540 at 562 that an error log is available. In some examples, a second error can occur at 564 (e.g., before external management controller 540 receives the error log), which management core 512 can accordingly process (as described herein) at 566. At 568, management core 512 can merge the second error (e.g., a second error log corresponding to the second error) into the error log, rather than having two separate error logs. For example, as described herein, management core 512 can set an appropriate bit flag for the second error in addition to the previously set bit flag (for the previous error). In some examples, if the second error is a same type as the first error, management core 512 can set a separate bit flag indicating multiple errors of the particular type. Further, although FIG. 5 illustrates a second error, in other examples, management core 512 can detect and accordingly merge additional errors into the error log as needed.

Returning to FIG. 3B, at step 312 one or more of the systems described herein receives an acknowledgement from the baseboard controller in response to the notification (e.g., at step 310). For example, management core 112 can receive an acknowledgement from baseboard controller 140.

The systems described herein can perform step 312 in a variety of ways. In one example, controller 440 can send a response to the notification from management core 412. For instance, in FIG. 5, external management controller 540 can send, at 570, an acknowledgement to management core 512.

Alternatively and/or additionally, at step 311, the baseboard controller can periodically query the management core for new errors. For example, rather than waiting for a notification from management core 412 (e.g., step 310), controller 440 can query management core 412 for new errors (e.g., updates to the error state in register 416 from a last query). If there have been no new errors, controller 440 can repeat the query (e.g., step 311) at a next polling cycle. Moreover, in some implementations controller 440 and management core 412 can operate in a hybrid mode, in which some errors (e.g., one or more specific types of errors such as higher priority errors) can be reported by management core 412 (e.g., step 310) and other errors (e.g., lower priority errors) can be collected by management core 412 and reported when controller 440 queries management core 412.

At step 314 one or more of the systems described herein provides the error log to the baseboard controller in response to a ready signal from the baseboard controller, which in some examples can correspond to the acknowledgement (e.g., at step 312) and/or the periodic query (e.g., at step 311 is new errors are to be reported). For example, management core 112 can provide the error log to baseboard controller 140.

The systems described herein can perform step 314 in a variety of ways. In one example, controller 440 can access or otherwise read the error log (e.g., from management core 412 and/or register 416) and store the error log in non-volatile storage 442. In FIG. 5, management core 512 can send, at 572, the error log to external management controller 540. Management core 512 can clear the error log in order to track new errors (e.g., error after sending the error log at 572). External management controller 540 can store, in its non-volatile memory, the received error log.

As detailed above, the systems and methods provided herein are directed to a Platform First Error Handling architecture (e.g., in which firmware sees all error state prior to exposing it to the operating system) in which the error handling firmware resides in a dedicated management core as opposed to another processing core or execution unit.

The systems and methods described herein can further be applied to a Machine Check Architecture (MCA). When an MCA error occurs, all MCA interrupts and exceptions can be redirected to the firmware, and MCA banks (e.g., registers) are cloaked to the operating system (OS). Once the firmware has seen the error, firmware can make a policy choice on whether to expose that error to the operating system by uncloaking the MCA bank (e.g., allowing the OS read the values in that MCA bank) and percolating the error (e.g., by sending an interrupt to the OS, if warranted by the error and requested by the OS).

In one example, on a threshold overflow or deferred error interrupt, the MCA bank can notify its processing core, and that core can send an interrupt to the management core/firmware. The processing core can then continue normal operation.

In another example, on a Machine Check Exception (MCE), the core will query the MCA banks and send an interrupt to the management core/firmware. The management core can (optionally) read the banks with valid errors, and then uncloak one or more MCA banks, causing microcode to generate an MCE to the operating system. From the OS perspective, the MCE can be taken precisely, as normal (e.g., as if the management core did not affect the error flow). In some examples, the management core can read MCA registers from a processor core without directly halting the core.

In some examples, error reporting (e.g., processor error reporting, peripheral device error reporting via an interface such as PCIe, etc.) and/or other reporting (e.g., PCIe DPC/hotplug events) can be offloaded to a management core (e.g., management core 112) with an out-of-band (OOB) reporting feature. When OOB error reporting is enabled, the management core can harvest info from root-ports, switches/retimers and end-points, etc. (e.g., which can be similar to an SMM mode of a processor). The management core can create an error log for in-band reporting (e.g., to the OS as described herein), and send a copy of the error log to a baseboard controller (e.g., baseboard controller 140) for OOB reporting. The management core can also manage other aspects of in-band state, such as clearing registers (e.g., on root-ports and end-points) after the in-band and OOB reporting.

In other words, in some implementations, the management core may manage two independent states in its memory: one for OOB reporting and one for the processor core. This entails understanding the Root Port config (which are enabled, and can include the bifurcation config), setting IO traps to prevent race conditions with the processor core, and keeping up with processor core interrupt policy depending on the error reporting handling mode (OS-first, FW-first, as described above with respect to cloaking) and runtime changes (polling for corrected errors (CEs) on subset of active root-ports, disable interrupts during system management interrupt (SMI) storms, etc.).

In one implementation, a device for an error handling management core includes a processor core, and a management core configured to detect an error of the processor core, and process the error independently from the processor core.

In some examples, the management core is further configured to cloak or uncloak the error from an operating system. In some examples, the management core is configured to cloak or uncloak the error from the operating system based on an error policy. In some examples, the error policy is programmable. In some examples, the error policy corresponds to microcode in the management core.

In some examples, cloaking the error comprises preventing the operating system from reading an error state for the error. In some examples, cloaking the error comprises suppressing an error interrupt to the operating system. In some examples, uncloaking the error comprises allowing the operating system to read an error state for the error. In some examples, uncloaking the error comprises sending an error interrupt to the operating system.

In some examples, the device includes a register for storing an error state corresponding to the error interrupt. In some examples, processing the error further comprises accessing the register to read the error state. In some examples, processing the error further comprises instructing the processor core to continue operations.

In one implementation, a system for an error handling management core includes a memory, and a processor including a processor core, a register for storing an error state of the processor core, and a management core. In some examples, the management core is configured to detect an error of the processor core, control read access to the error state in the register, and process the error independently from the processor core.

In some examples, the management core is configured to control read access to the error state based on an error policy. In some examples, the error policy corresponds to programmable microcode in the management core. In some examples, the management core is further configured to cloak the error from an operating system based on the error policy by preventing the operating system from reading the error state and suppressing an error interrupt to the operating system.

In some examples, the management core is further configured to uncloak the error from an operating system based on the error policy by allowing the operating system to read an error state for the error and sending an error interrupt to the operating system. In some examples, processing the error further comprises accessing the register to read the error state and instructing the processor core to continue operations.

In one implementation, a method for an error handling management core includes (i) detect, by a management core of a processor, an error of a processor core of the processor, (ii) controlling, by the management core, read access to an error state in a register based on an error policy, and (iii) processing the error independently from the processor core while the processor core continues operations. In some examples, the method includes providing read access to the error state for an operating system.

In some aspects, the techniques described herein relate to a device including: a processor core; and a management core configured to: detect an error of the processor core; and process the error independently from the processor core.

In some aspects, the techniques described herein relate to a device, wherein the management core is further configured to store an error log of the error in a non-volatile storage.

In some aspects, the techniques described herein relate to a device, wherein the management core is configured to interface with an external management controller to store the error log in the non-volatile storage by providing the error log to the external management controller in response to a ready signal from the external management controller.

In some aspects, the techniques described herein relate to a device, wherein the management core is configured to interface with the external management controller by: notifying the external management controller that the error log is available; receiving an acknowledgement from the external management controller as the ready signal in response to the notifying; and providing the error log to the external management controller.

In some aspects, the techniques described herein relate to a device, wherein the external management controller is configured to send the ready signal by querying the management core for errors.

In some aspects, the techniques described herein relate to a device, wherein the management core is further configured to: detect a second error of the processor core before receiving the ready signal from the external management controller; and merge, into the error log, a second error log corresponding to the second error.

In some aspects, the techniques described herein relate to a device, wherein the error log corresponds to a bit flag corresponding to an error type of the error and merging the second error log includes setting a second bit flag corresponding to a second error type of the second error.

In some aspects, the techniques described herein relate to a device, wherein the second error type matches the error type and setting the second bit flag includes setting a multiple error flag for the error type.

In some aspects, the techniques described herein relate to a device, wherein the management core is further configured to clear the error log in response to providing the error log to the external management controller.

In some aspects, the techniques described herein relate to a system including: a memory; a non-volatile storage; and a processor coupled to the memory and including: a processor core; a register for storing an error state of the processor core; and a management core configured to: detect an error of the processor core; control read access to the error state in the register; store the error state in the non-volatile storage; and process the error independently from the processor core.

In some aspects, the techniques described herein relate to a system, further including a baseboard controller including the non-volatile storage, wherein the management core is coupled to the baseboard controller and is configured to: detect a second error of the processor core; merge the error state with the second error to generate an error log; interface with the baseboard controller to store the error log in the non-volatile storage by providing the error log to the baseboard controller in response to a ready signal from the baseboard controller; and clear the error state in response to providing the error log to the baseboard controller.

In some aspects, the techniques described herein relate to a system, wherein the management core is configured to interface with the baseboard controller by: notifying the baseboard controller that the error log is available; receiving an acknowledgement from the baseboard controller in response to the notifying; and providing the error log to the baseboard controller.

In some aspects, the techniques described herein relate to a system, wherein the error log corresponds to a bit flag corresponding to an error type of the error and merging the second error log includes setting a second bit flag corresponding to a second error type of the second error.

In some aspects, the techniques described herein relate to a system, wherein the second error type matches the error type and setting the second bit flag includes setting a multiple error flag for the error type.

In some aspects, the techniques described herein relate to a method including: detecting, by a management core of a processor, an error of a processor core of the processor; storing, in a non-volatile storage of a baseboard controller, an error log of the error; controlling, by the management core, read access to an error state in a register based on an error policy; and processing the error independently from the processor core while the processor core continues operations.

In some aspects, the techniques described herein relate to a method, wherein storing the error log further includes: notifying the baseboard controller that the error log is available; receiving an acknowledgement from the baseboard controller in response to the notifying; providing the error log to the baseboard controller; and clearing the error log in response to providing the error log to the baseboard controller.

In some aspects, the techniques described herein relate to a method, wherein storing the error log further includes: receiving a query from the baseboard controller for an error update; providing the error log to the baseboard controller in response to the query, wherein the error log includes error updates from a prior query from the baseboard controller; and clearing the error log in response to providing the error log to the baseboard controller.

In some aspects, the techniques described herein relate to a method, further including: detecting a second error of the processor core before storing the error log in the non-volatile storage; merging, into the error log, a second error log corresponding to the second error; and providing the merged error log to the baseboard controller for storing in the non-volatile storage.

In some aspects, the techniques described herein relate to a method, wherein the error log corresponds to a bit flag corresponding to an error type of the error and merging the second error log includes setting a second bit flag corresponding to a second error type of the second error.

In some aspects, the techniques described herein relate to a method, wherein the second error type matches the error type and setting the second bit flag includes setting a multiple error flag for the error type.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAS that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a processor core; and
a management core configured to:
detect an error of the processor core; and
process the error independently from the processor core.

2. The device of claim 1, wherein the management core is further configured to store an error log of the error in a non-volatile storage.

3. The device of claim 2, wherein the management core is configured to interface with an external management controller to store the error log in the non-volatile storage by providing the error log to the external management controller in response to a ready signal from the external management controller.

4. The device of claim 3, wherein the management core is configured to interface with the external management controller by:
notifying the external management controller that the error log is available;
receiving an acknowledgement from the external management controller as the ready signal in response to the notifying; and
providing the error log to the external management controller.

5. The device of claim 3, wherein the external management controller is configured to send the ready signal by querying the management core for errors.

6. The device of claim 3, wherein the management core is further configured to:
detect a second error of the processor core before receiving the ready signal from the external management controller; and
merge, into the error log, a second error log corresponding to the second error.

7. The device of claim 6, wherein the error log corresponds to a bit flag corresponding to an error type of the error and merging the second error log comprises setting a second bit flag corresponding to a second error type of the second error.

8. The device of claim 7, wherein the second error type matches the error type and setting the second bit flag comprises setting a multiple error flag for the error type.

9. The device of claim 3, wherein the management core is further configured to clear the error log in response to providing the error log to the external management controller.

10. A system comprising:
a memory;
a non-volatile storage; and
a processor coupled to the memory and comprising:
a processor core;
a register for storing an error state of the processor core; and
a management core configured to:
detect an error of the processor core;
control read access to the error state in the register;
store the error state in the non-volatile storage; and
process the error independently from the processor core.

11. The system of claim 10, further comprising a baseboard controller comprising the non-volatile storage, wherein the management core is coupled to the baseboard controller and is configured to:
detect a second error of the processor core;
merge the error state with the second error to generate an error log;
interface with the baseboard controller to store the error log in the non-volatile storage by providing the error log to the baseboard controller in response to a ready signal from the baseboard controller; and
clear the error state in response to providing the error log to the baseboard controller.

12. The system of claim 11, wherein the management core is configured to interface with the baseboard controller by:
notifying the baseboard controller that the error log is available;
receiving an acknowledgement from the baseboard controller in response to the notifying; and
providing the error log to the baseboard controller.

13. The system of claim 11, wherein the error log corresponds to a bit flag corresponding to an error type of the error and merging the second error log comprises setting a second bit flag corresponding to a second error type of the second error.

14. The system of claim 13, wherein the second error type matches the error type and setting the second bit flag comprises setting a multiple error flag for the error type.

15. A method comprising:
detecting, by a management core of a processor, an error of a processor core of the processor;
storing, in a non-volatile storage of a baseboard controller, an error log of the error;
controlling, by the management core, read access to an error state in a register based on an error policy; and
processing the error independently from the processor core while the processor core continues operations.

16. The method of claim 15, wherein storing the error log further comprises:
notifying the baseboard controller that the error log is available;
receiving an acknowledgement from the baseboard controller in response to the notifying;
providing the error log to the baseboard controller; and
clearing the error log in response to providing the error log to the baseboard controller.

17. The method of claim 15, wherein storing the error log further comprises:
receiving a query from the baseboard controller for an error update;
providing the error log to the baseboard controller in response to the query, wherein the error log includes error updates from a prior query from the baseboard controller; and
clearing the error log in response to providing the error log to the baseboard controller.

18. The method of claim 15, further comprising:
detecting a second error of the processor core before storing the error log in the non-volatile storage;
merging, into the error log, a second error log corresponding to the second error; and
providing the merged error log to the baseboard controller for storing in the non-volatile storage.

19. The method of claim 18, wherein the error log corresponds to a bit flag corresponding to an error type of the error and merging the second error log comprises setting a second bit flag corresponding to a second error type of the second error.

20. The method of claim 19, wherein the second error type matches the error type and setting the second bit flag comprises setting a multiple error flag for the error type.
